(19) United States
(12) Patent Application Publication
(10) Pub. No.: US 2025/0105537 A1
(43) Pub. Date: Mar. 27, 2025

(54) STRADDLE MOUNT CONNECTOR

(71) Applicant: Dell Products L.P., Round Rock, TX (US)

(72) Inventors: James L. PETIVAN, Austin, TX (US); Isaac Q. WANG, Austin, TX (US); Chandra V. KRISHNASWAMY, Cedar Park, TX (US)

(73) Assignee: Dell Products L.P., Round Rock, TX (US)

(21) Appl. No.: 18/473,931

(22) Filed: Sep. 25, 2023

(51) Int. Cl. H01R 12/72; H01R 12/73

(52) U.S. Cl. CPC H01R 12/722; H01R 12/732

(57) ABSTRACT

An information handling resource may include a circuit board and a straddle mount connector mounted to an edge of the circuit board and configured to receive an edge connector of a second circuit board in order to electrically and mechanically couple the second circuit board to the circuit board. The straddle mount connector may include a first member surface mounted to a first side of the circuit board proximate to the edge and a second member surface mounted to a second side of the circuit board proximate to the edge, such that the second member and the first member define a receptacle for receiving the edge connector.

### TECHNICAL FIELD

The present disclosure relates in general to information handling systems, and more particularly to systems and methods for coupling a straddle mount connector to a circuit board.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems utilize one or more circuit boards. Some circuit boards may have a connector known as a straddle mount connector, a receptacle connector coupled to the circuit board at an edge of the circuit board, and wherein the connector “straddles” both sides of the circuit board at such edge. Once mounted, the straddle mount connector may receive another circuit board having an edge connector configured to mate with the straddle mount connector, thus providing electrical coupling between both circuit boards.

Despite their utility, the use of straddle mount connectors have disadvantages. For example, in order to facilitate mounting of straddle mount connectors onto an edge of a circuit board, it is often necessary to chamfer or bevel such edge, adding cost to manufacturing. As another example, in order to maximize signal integrity when using existing straddle mount connectors, resin-filled vias are often added to each end of ground voltage pads formed on the circuit board proximate to where the straddle mount connector is placed, also adding cost to manufacturing. As a further example, because straddle mount connectors mount horizontally to an edge of a circuit board and cannot be placed using a standard “pick-and-place” machine, existing straddle mount connectors must be placed manually by an operator, adding an additional assembly step and thus additional cost.

### SUMMARY

In accordance with the teachings of the present disclosure, the disadvantages and problems associated with existing approaches to mechanically mounting a straddle mount connector to a circuit board may be reduced or eliminated.

In accordance with embodiments of the present disclosure, an information handling system may include a processor and an information handling resource mechanically and electrically coupled to the processor. The information handling resource may comprise a circuit board and a straddle mount connector mounted to an edge of the circuit board and configured to receive an edge connector of a second circuit board in order to electrically and mechanically couple the second circuit board to the circuit board. The straddle mount connector may include a first member surface mounted to a first side of the circuit board proximate to the edge and a second member surface mounted to a second side of the circuit board proximate to the edge, such that the second member and the first member define a receptacle for receiving the edge connector.

In accordance with these and other embodiments of the present disclosure, an information handling resource may include a circuit board and a straddle mount connector mounted to an edge of the circuit board and configured to receive an edge connector of a second circuit board in order to electrically and mechanically couple the second circuit board to the circuit board. The straddle mount connector may include a first member surface mounted to a first side of the circuit board proximate to the edge and a second member surface mounted to a second side of the circuit board proximate to the edge, such that the second member and the first member define a receptacle for receiving the edge connector.

In accordance with these and other embodiments of the present disclosure, a method may be provided for making an information handling resource having a circuit board and a straddle mount connector mounted to an edge of the circuit board and configured to receive an edge connector of a second circuit board in order to electrically and mechanically couple the second circuit board to the circuit board. The method may include surface mounting a first member of the straddle mount connector to a first side of the circuit board proximate to the edge and surface mounting a second member of the straddle mount connector to a second side of the circuit board proximate to the edge, such that the second member and the first member define a receptacle for receiving the edge connector.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIG. 2 illustrates a perspective view of a first circuit board having a straddle mount connector and a second circuit board configured to electrically and mechanically couple to the first circuit board via the straddle mount connector, in accordance with embodiments of the present disclosure;

FIG. 3 illustrates a perspective view of a straddle mount connector, in accordance with embodiments of the present disclosure;

FIG. 4A illustrates a side elevation view of a first step of mounting a straddle mount connector to a circuit board, in accordance with embodiments of the present disclosure; and

FIG. 4B illustrates a side elevation view of a second step of mounting a straddle mount connector to a circuit board, in accordance with embodiments of the present disclosure.

### DETAILED DESCRIPTION

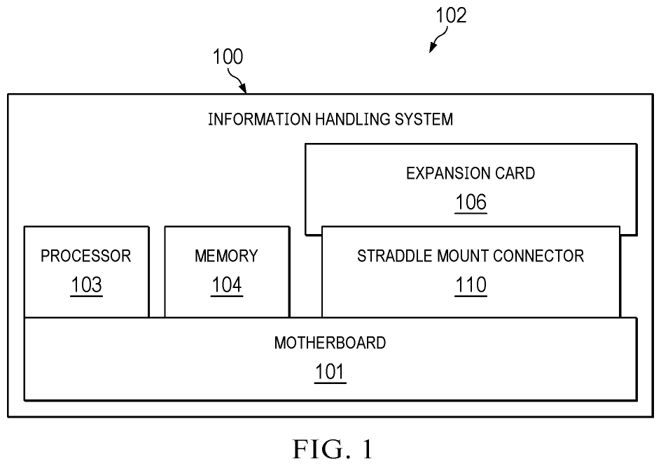

Preferred embodiments and their advantages are best understood by reference to FIGS. 1 through 4B wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage one devices, or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

For the purposes of this disclosure, circuit boards may broadly refer to printed circuit boards (PCBs), printed wiring boards (PWBs), printed wiring assemblies (PWAS), etched wiring boards, and/or any other board or similar physical structure operable to mechanically support and electrically couple electronic components (e.g., packaged integrated circuits, slot connectors, etc.). A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

FIG. 1 illustrates a block diagram of selected components of an example information handling system 102. In some embodiments, information handling system 102 may comprise a server. In other embodiments, information handling system 102 may comprise networking equipment for facilitating communication over a communication network. In yet other embodiments, information handling system 102 may comprise a personal computer, such as a laptop, notebook, or desktop computer.

As shown in FIG. 1, information handling system 102 may include a chassis 100 that houses a motherboard 101, a processor 103 coupled to motherboard 101, a memory 104 coupled to motherboard 101, an expansion card 106 mechanically and electrically coupled to motherboard 101 via a straddle mount connector 110.

Chassis 100 may include any suitable housing or enclosure configured to house the various components of information handling system 102, and may be constructed from metal, plastic, and/or any other suitable material.

Motherboard 101 may comprise a circuit board configured to provide structural support for one or more information handling resources of information handling system 102 and/or electrically couple one or more of such information handling resources to each other and/or to other electric or electronic components external to information handling system 102.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a storage resource, memory system 104, and/or another component of information handling system 102.

Memory 104 may be communicatively coupled to processor 103 and may comprise any system, device, or apparatus operable to retain program instructions or data for a period of time (e.g., computer-readable media). Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off. In particular embodiments, memory 104 may comprise dynamic random access memory (DRAM).

Straddle mount connector 110 may comprise a receptacle connector fixedly mounted relative to motherboard 101 on an edge of motherboard 101 and “straddling” both sides of motherboard 101 at such edge, and may be constructed to mechanically couple expansion card 106 within such straddle mount connector 110 and to electrically couple such expansion card 106 to motherboard 101, processor 103, and/or other components of information handling system 102. Straddle mount connector 110 may comprise a socket including a receptacle slot or other opening configured to removably receive a corresponding mating edge connector of an expansion card 106.

Expansion card 106 may comprise a circuit board configured to perform a particular functionality within information handling system 102. For example, in some embodiments, expansion card 106 may comprise a riser card.

In addition to motherboard 101, processor 103, memory 104, expansion card 106, and straddle mount connector 110, information handling system 102 may include one or more other information handling resources.

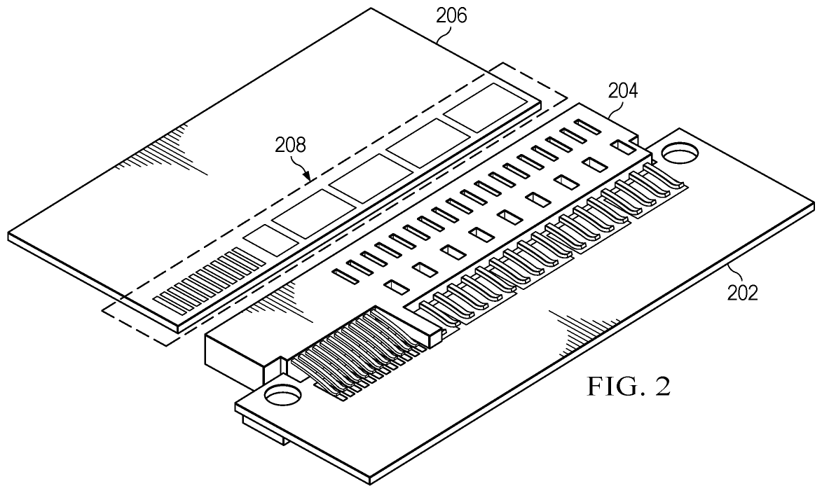

FIG. 2 illustrates a perspective view of a first circuit board 202 having a straddle mount connector 204 and a second circuit board 206 having an edge connector 208 configured to electrically and mechanically couple to first circuit board 202 via straddle mount connector 204, in accordance with embodiments of the present disclosure. In some embodiments, first circuit board 202 and straddle mount connector 204 may implement motherboard 101 and straddle mount connector 110, respectively.

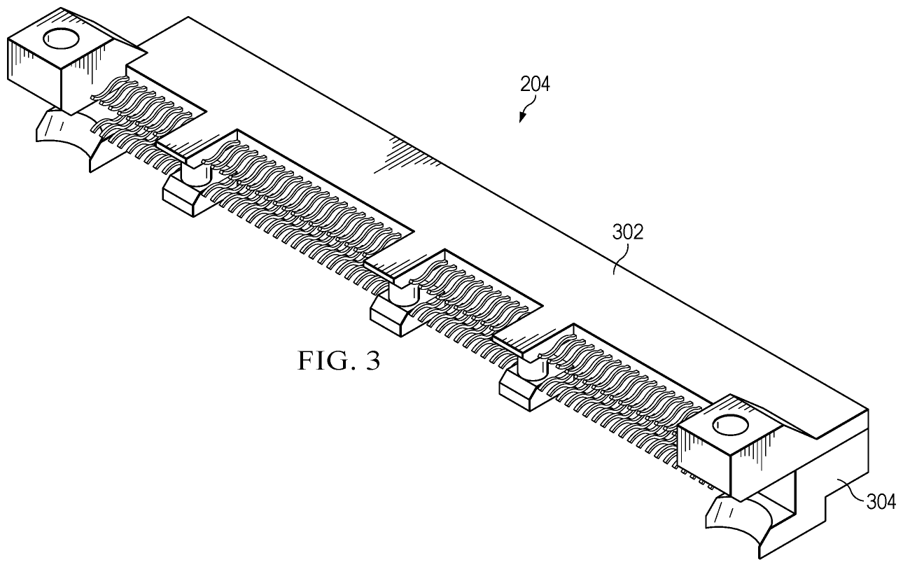

FIG. 3 illustrates a perspective view of straddle mount connector 204, in accordance with embodiments of the present disclosure. As shown in FIG. 3, straddle mount connector 204 may comprise two interlocking pieces: a first member 302 and a second member 304. As described in greater detail below, first member 302 may be surface mounted on a first side of first circuit board 202 along with other components surface mounted to such first side, and second member 304 may be surface mounted on a second side of first circuit board 202 along with other components surface mounted to such second side, such that together, first member 302 and second member 304 form a receptacle for receiving edge connector 208 of second circuit board 206.

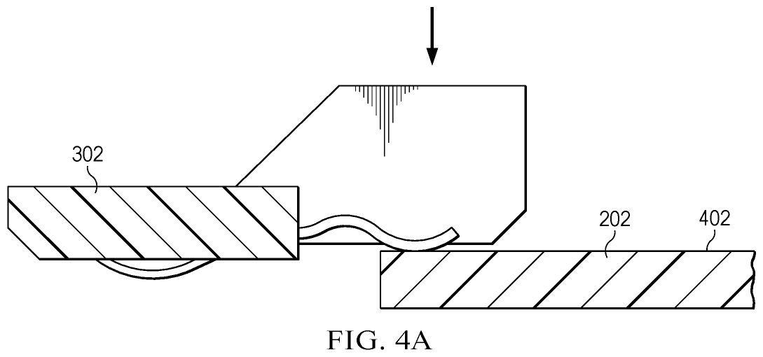

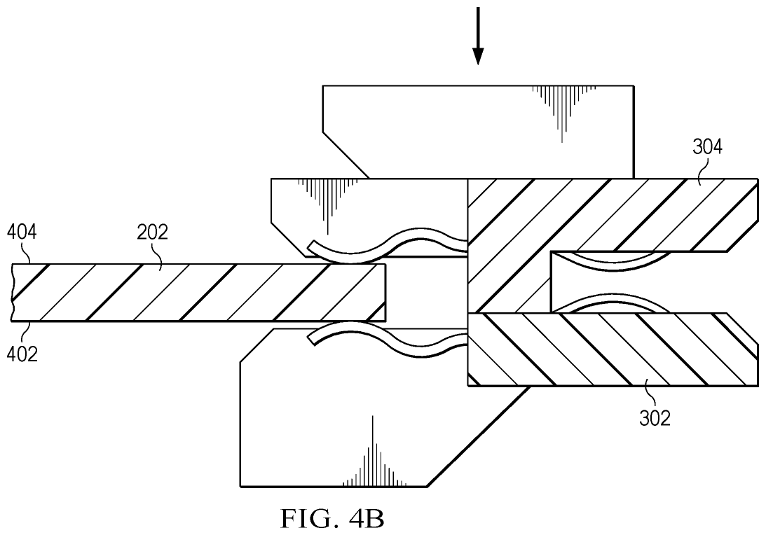

FIG. 4A illustrates a side elevation view of a first step of mounting straddle mount connector 204 to circuit board 202, in accordance with embodiments of the present disclosure. In such first step, a surface-mount technology (SMT) component placement system or a “pick-and-place machine” may, along with other components to be surface mounted onto first side 402 of circuit board 202, place first member 302 at an edge of circuit board 202. A solder reflow process step for first side 402 may be used to mechanically and electrically couple first member 302 to circuit board 202.

FIG. 4B illustrates a side elevation view of a second step of mounting straddle mount connector 204 to circuit board 202, in accordance with embodiments of the present disclosure. In such second step, an SMT component placement system, along with other components to be surface mounted onto second side 404 of circuit board 202, place second member 304 at an edge of circuit board 202. A solder reflow process step for second side 404 may be used to mechanically and electrically couple second member 304 to circuit board 202.

While the solder reflow process steps described above may provide some force to retain first member 302 and second member 304 onto circuit board 202, it may be critical to provide further mechanical coupling between first member 302 and second member 304 to provide more mechanical retention force of straddle mount connector 204 to circuit board 202, as well as sustain the integrity of the contact geometry between first member 302 and second member 304 to ensure satisfactory electrical connectivity of straddle mount connector 204 to any edge connector 208 inserted into straddle mount connector 204.

In some embodiments, such additional mechanical retention may be applied by terminal position assurance features. To ensure that terminals/pins of relevant connectors are maintained at a particular location (e.g., a fixed distance from housing wall), a small piece of plastic (like a wedge) may be pushed into a slot in the housing at the back of the pins along an entire row of pins. Such terminal position assurance features may be retained in the housing using locking bumps. Such terminal position assurance may be used in either or both of first member 302 and second member 304. Inclusion of such terminal position assurance features may ensure pins/contacts are positively touching corresponding gold pads on the mating board with sufficient normal force.

In these and other embodiments, screws or other fasteners may be used to mechanically coupled first member 302 and second member 304 and maintain a desired contact gap and/or normal force between pins of the relevant connectors. In some of such embodiments, such screws or other fasteners may also mechanically engage with circuit board 202.

In these and other embodiments, one or more mechanical clips may be used to maintain a desired contact gap and/or normal force between pins of the relevant connectors.

In these and other embodiments, a glue or other adhesive may be used to maintain a desired contact gap and/or normal force between pins of the relevant connectors. For example, adhesive may be strategically placed on second member 304 such that during the solder reflow process following placement of second member 304 onto circuit board 202, the adhesive melts between first member 302 and second member 304 and adheres first member 302 to second member 304.

In these and other embodiments, a fork-lock or similar retention device may be used to maintain a desired contact gap and/or normal force between pins of the relevant connectors.

In these and other embodiments, a sleeve-type retention device may be used to maintain a desired contact gap and/or normal force between pins of the relevant connectors.

Using the systems and methods herein may enable mounting of a straddle mount connector to a circuit board without the need of chamfering/beveling of an edge of the circuit board, without the placement of resin-filled vias proximate to the edge, and without a special assembly apparatus or manual process needed to mount the straddle mount connector.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. An information handling system comprising:
a processor; and
an information handling resource mechanically and electrically coupled to the processor and comprising:
a circuit board; and
a straddle mount connector mounted to an edge of the circuit board and configured to receive an edge connector of a second circuit board in order to electrically and mechanically couple the second circuit board to the circuit board, the straddle mount connector comprising:
a first member surface mounted to a first side of the circuit board proximate to the edge; and
a second member surface mounted to a second side of the circuit board proximate to the edge, such that the second member and the first member define a receptacle for receiving the edge connector.

2. The information handling system of claim 1, the straddle mount connector further comprising one or more mechanical features configured to create a mechanical force between the first member and the second member to ensure at least one of a desired contact gap and a normal force between pins of the straddle mount connector.

3. The information handling system of claim 2, wherein the one or more mechanical features comprise one or more terminal position assurance features.

4. The information handling system of claim 2, wherein the one or more mechanical features comprise one or more fasteners.

5. The information handling system of claim 2, wherein the one or more mechanical features comprise a mechanical clip.

6. The information handling system of claim 2, wherein the one or more mechanical features comprise an adhesive.

7. The information handling system of claim 2, wherein the one or more mechanical features comprise a fork-lock.

8. An information handling resource comprising:
a circuit board; and
a straddle mount connector mounted to an edge of the circuit board and configured to receive an edge connector of a second circuit board in order to electrically and mechanically couple the second circuit board to the circuit board, the straddle mount connector comprising:
a first member surface mounted to a first side of the circuit board proximate to the edge; and
a second member surface mounted to a second side of the circuit board proximate to the edge, such that the second member and the first member define a receptacle for receiving the edge connector.

9. The information handling resource of claim 8, the straddle mount connector further comprising one or more mechanical features configured to create a mechanical force between the first member and the second member to ensure at least one of a desired contact gap and a normal force between pins of the straddle mount connector.

10. The information handling resource of claim 9, wherein the one or more mechanical features comprise one or more terminal position assurance features.

11. The information handling resource of claim 9, wherein the one or more mechanical features comprise one or more fasteners.

12. The information handling resource of claim 9, wherein the one or more mechanical features comprise a mechanical clip.

13. The information handling resource of claim 9, wherein the one or more mechanical features comprise an adhesive.

14. The information handling resource of claim 9, wherein the one or more mechanical features comprise a fork-lock.

15. A method for making an information handling resource having a circuit board and a straddle mount connector mounted to an edge of the circuit board and configured to receive an edge connector of a second circuit board in order to electrically and mechanically couple the second circuit board to the circuit board, the method comprising:
surface mounting a first member of the straddle mount connector to a first side of the circuit board proximate to the edge; and
surface mounting a second member of the straddle mount connector to a second side of the circuit board proximate to the edge, such that the second member and the first member define a receptacle for receiving the edge connector.

16. The method of claim 15, further comprising creating, with one or more mechanical features, a mechanical force between the first member and the second member to ensure at least one of a desired contact gap and a normal force between pins of the straddle mount connector.

17. The method of claim 16, wherein the one or more mechanical features comprise one or more terminal position assurance features.

18. The method of claim 16, wherein the one or more mechanical features comprise one or more fasteners.

19. The method of claim 16, wherein the one or more mechanical features comprise a mechanical clip.

20. The method of claim 16, wherein the one or more mechanical features comprise an adhesive.

21. The method of claim 16, wherein the one or more mechanical features comprise a fork-lock.
